(19) United States
(12) Patent Application Publication
(10) Pub. No.: US 2026/0187656 A1
(43) Pub. Date: Jul. 2, 2026

(54) SYSTEM FOR MONITORING VEHICLE CARBON FOOTPRINT AND REDUCING COMPUTATIONAL LOAD IN CARBON-AWARE VEHICLE ROUTING

(71) Applicant: Pin-Huan CHOU, Taoyuan City (TW)

(72) Inventors: Pin-Huan CHOU, Taoyuan City (TW); Kai-Cheng CHUANG, Nantou County (TW)

(73) Assignee: Pin-Huan CHOU, Taoyuan City (TW)

(21) Appl. No.: 19/549,677

(22) Filed: Feb. 25, 2026

Related U.S. Application Data
(63) Continuation-in-part of application No. 18/664,154, filed on May 14, 2024.
(60) Provisional application No. 63/502,119, filed on May 15, 2023.

(51) Int. Cl. G06Q 30/018; G01C 21/34; G06Q 50/40

(52) U.S. Cl. CPC G06Q 30/018; G01C 21/3469; G06Q 50/40

(57) ABSTRACT

A carbon-aware vehicle routing system is provided for improving computational efficiency during route planning. The system stores road network data in memory and employs a processing circuit to execute a routing application. A route search region is established between a vehicle's current location and destination. Assessment points within the route search region are evaluated to identify high-emission points when carbon-emission levels exceed a predefined threshold. One or more high-emission spatial zones are defined using proximity-based expansion or graph connectivity relationships among adjacent high-emission points. The system constructs a route-search graph topology corresponding to a subgraph of the route search region that excludes the high-emission spatial zones. By reducing the number of nodes and edges involved in route computation, the system decreases computational load and resource intensity. A candidate route is generated through route computation performed on the reduced graph topology.

### CROSS-REFERENCE TO RELATED APPLICATION

This application is a continuation-in-part of U.S. patent application Ser. No. 18/664,154, filed on May 14, 2024, the entire contents of which are incorporated herein by reference in its entirety.

### BACKGROUND OF THE INVENTION

### 1. Field of the Invention

The present invention relates to intelligent transportation systems and computer-implemented route optimization technologies, and more particularly to a system for monitoring vehicle carbon footprint and reducing computational load in carbon-aware vehicle routing.

### 2. Description of the Prior Art

With the rapid advancement of logistics transportation and the sharing economy, Vehicle Management Systems (VMS) have been widely deployed in applications such as freight logistics, and passenger transportation. Conventional vehicle management systems typically rely on Global Positioning System (GPS) or Location-Based Services (LBS) technologies to obtain real-time geographic locations of transportation vehicles. These systems integrate vehicle location data with vehicle utilization demands transmitted from user-end electronic devices, such as smartphones, to generate dispatch instructions and transportation routes.

In the field of route planning technology, existing solutions focus primarily on improving fuel efficiency or reducing energy consumption. For example, certain systems analyze historical driving behavior data collected from onboard sensors—including accelerometers, gyroscopes, and GPS modules—to evaluate driver habits such as acceleration, braking, turning, and lane changing. Based on predicted fuel consumption models, multiple advisory routes may be generated between a starting location and a destination, and a route associated with lower estimated fuel consumption is selected.

However, existing technologies predominantly focus on selecting an optimal route from among fully constructed route candidates based on fuel efficiency, or battery condition. These approaches generally perform route computation over an entire route search region without restructuring the underlying graph topology. Consequently, when the route search region contains a large number of nodes and edges, route computation may incur significant computational resource intensity, including increased memory access operations and graph traversal complexity.

### SUMMARY OF THE INVENTION

The objective of the present invention is to disclose a system for monitoring vehicle carbon footprint and reducing computational load in carbon-aware vehicle routing, including: at least one memory unit storing road network data; and at least one processing circuit operatively coupled to the memory unit. The processing circuit executes an application program to: define a route search region between a current location and a destination of a transportation vehicle based on the road network data; identify a plurality of assessment points within the route search region, and determine that at least one of the assessment points is a high-emission point when a carbon-emission level of the at least one assessment point exceeds a predefined threshold; define at least one high-emission spatial zone within the route search region, by a proximity distance relative to the high-emission point, or by graph connectivity relationship between a plurality of adjacent high-emission points; construct a route-search graph topology with a plurality of nodes representing intersections and a plurality of edges representing road segments in a subgraph of the road network data corresponding to the route search region and excluding the high-emission spatial zone, wherein the route-search graph topology includes fewer nodes and fewer edges to reduce a resource intensity of route computation over the subgraph than over a graph corresponding to the route search region including the high-emission spatial zone, thereby reducing computational load of the processing circuit; and construct a candidate route by performing route computation on the route-search graph topology.

In one embodiment, the carbon-emission level of each assessment point is determined based on at least one of: real-time traffic density data, average vehicle speed data, or historical carbon footprint records used to estimate the carbon-emission level and compare the carbon-emission level with the predefined threshold. The carbon-emission level may be determined using a predefined emission model stored in the memory unit.

In one embodiment, the transportation vehicle is selected from a group consisting of bicycle, electric bicycle (E-bike), motorcycle, scooter, electric motorcycle, electric scooter, gasoline-powered vehicle, and electric vehicle.

In one embodiment, the assessment points correspond to intersections, road-segment midpoints, or discretized coordinate grid points derived from the road network data.

In one embodiment, defining the high-emission spatial zone based on the proximity distance includes applying a region-growing algorithm that expands from the high-emission point until a boundary condition is satisfied.

In one embodiment, defining the high-emission spatial zone based on the graph connectivity relationship includes performing a connected-component analysis on the adjacent high-emission points.

In one embodiment, the high-emission spatial zone is represented as a polygonal boundary defined in a geographic coordinate system or as a node set in a directed graph data structure.

In one embodiment, the processing circuit dynamically recalculates the high-emission spatial zone prior to each route computation cycle based on updated carbon-emission levels of the assessment points.

In one embodiment, the processing circuit adjusts a spatial boundary of the route search region according to a distance between the current location and the destination, and constructs the route search region using road segments within the adjusted spatial boundary.

In one embodiment, the processing circuit further reintroduces one or more nodes and associated edges previously excluded due to being located within the high-emission spatial zone into the subgraph when no feasible candidate route is constructed in the subgraph.

In one embodiment, the memory unit stores the road network data as a directed graph data structure including the plural nodes and the plural edges, and the processing circuit constructs the route-search graph topology by selecting a subset of the nodes and the edges from the directed graph data structure.

In one embodiment, excluding the high-emission spatial zone reduces a number of memory access operations required during route computation and improves cache utilization efficiency and reduces memory latency of the processing circuit.

In one embodiment, the processing circuit performs parallel route computations on multiple subgraphs derived from partitioning the route search region to further reduce computation time. Each subgraph may be processed by a separate processing core.

In one embodiment, the processing circuit partitions the route search region into a plurality of subgraphs based on a load-balancing criterion that distributes the nodes and the edges across multiple processing units, performs parallel route computations on the plurality of subgraphs, and reconciles boundary nodes between adjacent subgraphs to construct the candidate route.

### BRIEF DESCRIPTION OF THE DRAWINGS

The invention, as well as a preferred mode of use and advantages thereof, will be best understood by referring to the following detailed description of an illustrative embodiment in conjunction with the accompanying drawings, wherein:

FIG. 1A is a schematic illustration of a system 100 for monitoring vehicle carbon footprint and reducing computational load in carbon-aware vehicle routing according to an embodiment of the present invention;

FIGS. 1B and 1C are schematic illustrations for determining assessment points to be high-emission points in a route search region between a current location and a destination of a transportation vehicle according to an embodiment of the present invention;

FIGS. 2A and 2B are schematic illustrations of determining two high-emission spatial zones respectively according to two embodiments of the present invention;

FIG. 3 is a schematic illustration of constructing a route-search graph topology according to an embodiment of the present invention;

FIG. 4 is a schematic illustration of constructing a candidate route according to the present invention; and

FIG. 5 shows a flowchart of operation executed by the processing circuit according to an embodiment of the present invention.

### DETAILED DESCRIPTION OF THE PREFERRED EMBODIMENTS

To better illustrate the advantages of the system for monitoring vehicle carbon footprint and reducing computational load in carbon-aware vehicle routing according to the present invention and its contributions to the art, preferred embodiments of the present invention will be described in detail concerning the attached drawings hereafter.

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible as needed, a person having ordinary knowledge in the art may, select, combine, or modify some or all of the technical features in any one of the embodiments, within the spirit and scope of the present invention.

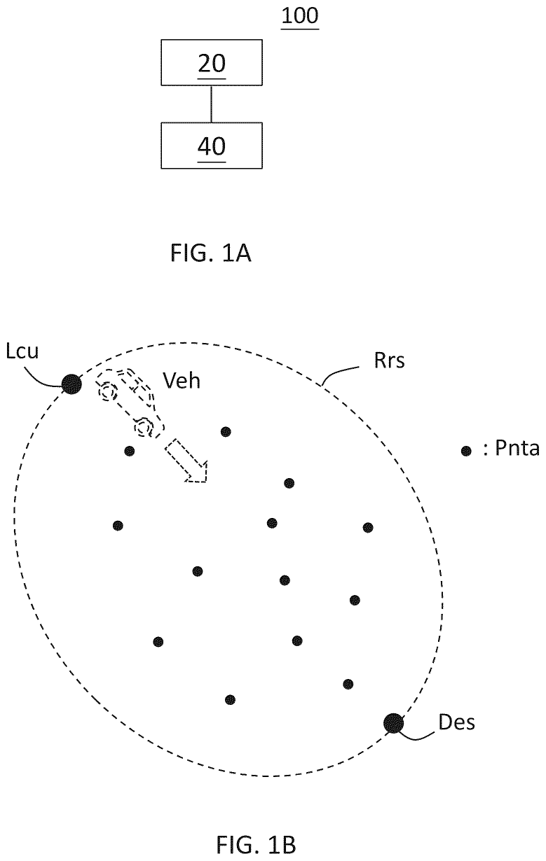

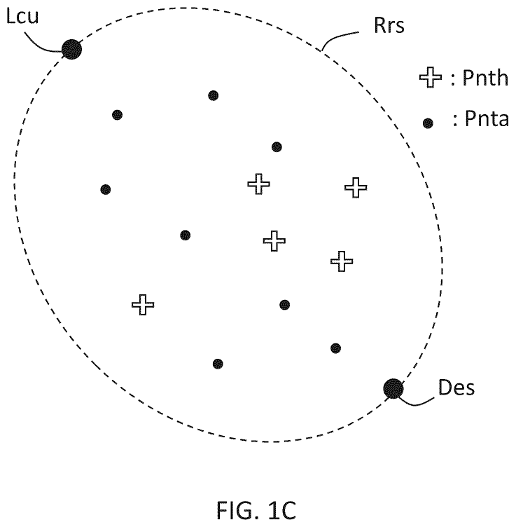

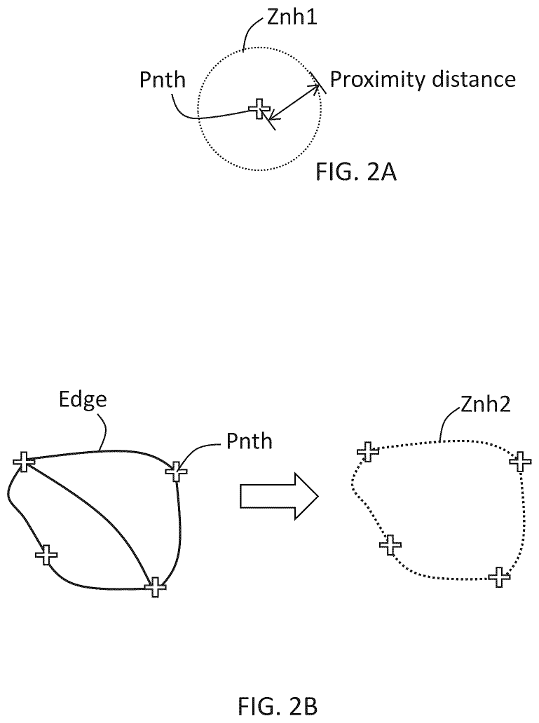

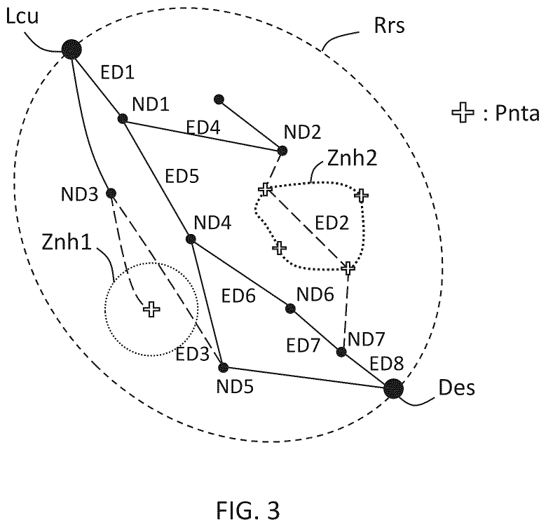

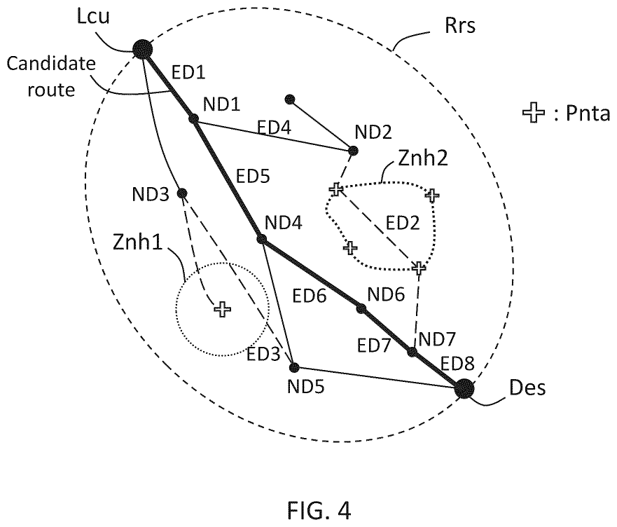

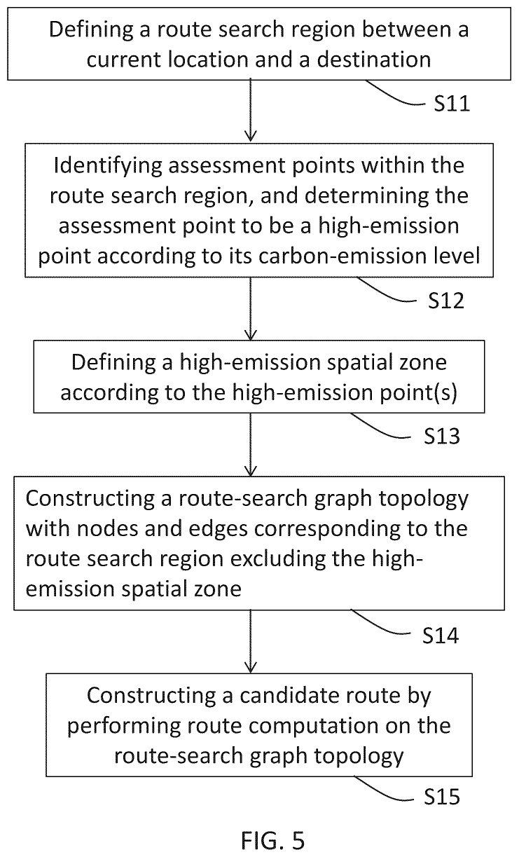

In one perspective of the present invention, a system 100 for monitoring vehicle carbon footprint and reducing computational load in carbon-aware vehicle routing is provided. The system 100 includes at least one memory unit 20 and at least one processing circuit 40 operatively coupled to the memory unit 20 (FIG. 1A). The at least one memory unit 20 stores road network data. Referring to the flowchart shown in FIG. 4, the processing circuit 40 executes an application program to: define a route search region Rrs between a current location Lcu and a destination Des of a transportation vehicle Veh based on the road network data (FIG. 1B); identify a plurality of assessment points within the route search region Rrs, and determine that at least one of the assessment points Pnta is at least one high-emission point Pnth when a carbon-emission level of the at least one assessment point Pnta exceeds a predefined threshold (FIG. 1C); define at least one high-emission spatial zone (Znh1, Znh2) within the route search region Rrs, by a proximity distance relative to the high-emission point (FIG. 2A), or by graph connectivity relationship between a plurality of adjacent high-emission points (FIG. 2B); construct a route-search graph topology with a plurality of nodes (FIG. 3, ND1 to ND8) representing intersections and a plurality of edges (ED1 to ED8) representing road segments in a subgraph of the road network data corresponding to the route search region Rrs and excluding the high-emission spatial zones Znh1 and Znh2, wherein the route-search graph topology includes fewer nodes and fewer edges to reduce a resource intensity of route computation over the subgraph than over a graph corresponding to the route search region Rrs including the high-emission spatial zones Znh1 and Znh2 (including the high-emission points Pnth and their connected neighboring road), thereby reducing computational load of the processing circuit 40; and construct a candidate route (for example: candidate route connected by Lcu, ED1, ND1, ED5, ND4, ED6, ND6, ED7, ND7, ED8, and Des, in FIG. 5) by performing route computation on the route-search graph topology. The route search region Rrs may be determined using geographic boundaries (for example, oval, rectangle, or other geographic boundaries), corridor constraints, or estimated travel ranges so as to confine route computation to a relevant subset of the overall road network. Within the defined route search region Rrs, the processing circuit 40 identifies a plurality of assessment points Pnta. The assessment points Pnta may correspond to selected nodes, road segments, or sampling locations within the road network. When the carbon-emission level of at least one assessment point Pnta exceeds a predefined threshold, that assessment point Pnta is designated as the high-emission point Pnth. After defining the high-emission spatial zones Znh1 and Znh2, the processing circuit 40 constructs a route-search graph topology corresponding to a subgraph of the route search region Rrs that excludes the high-emission spatial zones Znh1 and Znh2. Nodes and edges located within the high-emission spatial zones Znh1 and Znh2 are removed or excluded from the subgraph. As a result, the route-search graph topology includes fewer nodes and fewer edges than a graph that includes the high-emission spatial zones Znh1 and Znh2. This reduction decreases the effective search space for route computation and lowers the resource intensity of route computation, thereby reducing computational load of the processing circuit 40. Because the candidate route is generated from a subgraph excluding the high-emission spatial zones Znh1 and Znh2, the resulting route avoids areas associated with elevated carbon emissions while achieving improved computational efficiency.

Referring to FIG. 1, the processing circuit 40 is operatively coupled to the memory unit 20. The term ‘operatively coupled,’ may refer to a connection (whether direct or indirect) that allows for the communication of data and control signals between the components.

In one embodiment, the carbon-emission level of each assessment point Pnta is determined based on at least one of: real-time traffic density data, average vehicle speed data, or historical carbon footprint records used to estimate the carbon-emission level and compare the carbon-emission level with the predefined threshold. The real-time traffic density data may be obtained from traffic monitoring systems, vehicle telemetry, or third-party data providers, and may reflect current congestion levels or vehicle flow rates within the route search region Rrs. The average vehicle speed data may be derived from sensor measurements, navigation services, or aggregated mobility data, and may be correlated with emission models to estimate fuel consumption and corresponding carbon output. In addition, historical carbon footprint records associated with similar routes, vehicle types, or operating conditions may be referenced to improve estimation accuracy. The processing circuit 40 may apply a carbon-emission estimation model that integrates one or more of the foregoing data sources to calculate an emission value for each assessment point Pnta and compare the calculated emission value to the predefined threshold in order to determine whether the assessment point Pnta qualifies as the high-emission point Pnth.

In one embodiment, the transportation vehicle Veh is selected from a group consisting of bicycle, electric bicycle (E-bike), motorcycle, scooter, electric motorcycle, electric scooter, gasoline-powered vehicle, and electric vehicle. The disclosed system 100 is not limited to a particular vehicle propulsion type and may be adapted for use with human-powered vehicles, hybrid vehicles, or fully motorized vehicles. For electrically powered vehicles, the carbon-emission estimation may account for electricity consumption and associated upstream carbon intensity of the power source. For gasoline-powered or other combustion-engine vehicles, the carbon-emission estimation may be based on fuel consumption rates, engine characteristics, and operating conditions. For human-powered vehicles, such as bicycles, carbon-emission levels may be estimated based on indirect environmental factors, including route congestion or infrastructure impact. Accordingly, the system 100 may be configured to apply vehicle-type-specific emission models to determine carbon-emission levels and to perform carbon-aware route computation across a diverse range of transportation modalities.

In one embodiment, the assessment points Pnta correspond to intersections, road-segment midpoints, or discretized coordinate grid points derived from the road network data. The intersections may be represented by graph nodes within the road network topology and may serve as natural sampling locations for evaluating localized carbon-emission levels. The road-segment midpoints may be defined along edges of the road network graph to capture emission characteristics occurring between intersections, thereby providing a more granular representation of traffic flow and vehicle operating conditions. In addition, discretized coordinate grid points may be generated by partitioning the route search region Rrs into a plurality of spatial grid cells based on geographic coordinates (not shown), such as latitude and longitude divisions, and associating each grid point with nearby road network elements. By defining assessment points Pnta in one or more of these forms, the system 100 enables flexible spatial sampling of carbon-emission levels and supports adaptive resolution in emission evaluation within the route search region Rrs.

In one embodiment, defining the high-emission spatial zone Znh1 based on the proximity distance (FIG. 2A) includes applying a region-growing algorithm that expands from the high-emission point Pnth until a boundary condition is satisfied. The region-growing algorithm may iteratively include neighboring nodes or edges (FIGS. 4 and 5, the edges shown in dashed lines connected between the high-emission point Pnth and the node ND3, and another edge shown in dashed line between the nodes ND3 and ND5) within the road network graph that fall within a predetermined proximity distance or satisfy predefined emission-related criteria. Expansion may proceed radially in geographic space or along graph connectivity paths (edges), depending on implementation needs. The boundary condition of the region-growing algorithm may be defined according to one or more quantitative or topological criteria. For example, expansion from the high-emission point Pnth may terminate when a maximum radial distance or cumulative path distance from the original high-emission point is reached. In other implementations, expansion may cease when neighboring nodes or edges exhibit carbon-emission levels below a secondary emission threshold, thereby indicating that the surrounding area no longer exhibits concentrated high-emission characteristics. The boundary condition may additionally include exceeding a predefined geographic area limit, a maximum number of included nodes or edges, or a computational constraint designed to prevent excessive zone growth.

In one embodiment, defining the high-emission spatial zone Znh2 based on the graph connectivity relationship includes performing a connected-component analysis on the adjacent high-emission points (FIG. 2B). After identifying a plurality of high-emission points Pnth, the processing circuit 40 analyzes the underlying graph structure to determine whether two or more high-emission points Pnth are connected through one or more edges representing road segments. High-emission points Pnth that are mutually reachable through continuous paths (edges) in the graph may be grouped into the same connected component. The connected-component analysis may be implemented using graph traversal techniques, such as depth-first search (DFS), breadth-first search (BFS), union-find data structures, or other equivalent graph clustering algorithms. During traversal, the processing circuit 40 may evaluate adjacency relationships between nodes and may optionally consider edge attributes, such as traffic flow direction, emission continuity, or road classification, to determine whether connectivity criteria are satisfied. In some embodiments, connectivity may be limited to high-emission points Pnth that are directly adjacent or separated by no more than a predefined number of intermediate nodes. Once one or more connected components of high-emission points are identified, each connected component may be designated as the high-emission spatial zone Znh2. In this manner, the high-emission spatial zone reflects not merely isolated high-emission points Pnth but clusters of emission-intensive regions that are structurally interconnected within the road network topology. This approach allows the system 100 to capture extended high-emission corridors or regions formed by contiguous road segments exhibiting elevated carbon-emission levels. Consequently, subsequent exclusion of such connected components during construction of the route-search graph topology more accurately represents emission-intensive areas and supports effective reduction of computational load.

In one embodiment, the high-emission spatial zone may be represented as a polygonal boundary defined in a geographic coordinate system or as a node set in a directed graph data structure (not shown). The high-emission spatial zone is represented in a form suitable for spatial computation or graph-based processing. For example, the high-emission spatial zone may be represented as a polygonal boundary in a geographic coordinate system, such as latitude-longitude coordinates or projected map coordinates. The polygonal boundary may be generated based on the outermost points included in the region-growing process or derived from the convex hull, concave hull, or other boundary-construction techniques applied to the set of the high-emission points Pnth. Such a polygonal representation enables efficient spatial querying, intersection testing, and geographic filtering of road segments or intersections that fall within the defined boundary. In one embodiment, the high-emission spatial zone is represented as a node set in a directed graph data structure corresponding to the road network. In this representation, the high-emission spatial zone may consist of a collection of node identifiers and associated edge identifiers that have been classified as belonging to the high-emission region. The directed graph structure may preserve edge directionality to reflect one-way traffic flow or asymmetric road conditions. By representing the high-emission spatial zone as a node set or subgraph within the directed graph, the processing circuit 40 can directly perform graph pruning operations, such as removing or disabling selected nodes and edges during construction of the route-search graph topology.

In one embodiment, the processing circuit 40 dynamically recalculates the high-emission spatial zone prior to each route computation cycle based on updated carbon-emission levels of the assessment points Pnta. The updated carbon-emission levels may be obtained from real-time traffic data feeds, refreshed vehicle telemetry, newly received environmental data, or periodically updated historical emission databases. Upon receiving such updated data, the processing circuit 40 re-evaluates the carbon-emission level at each assessment point Pnta and re-determines whether the assessment point Pnta satisfies the predefined threshold for classification as a high-emission point Pnth. When changes in emission levels are detected, the processing circuit 40 correspondingly redefines the high-emission spatial zone using the previously described proximity-based expansion, graph connectivity analysis, or a combination thereof. As a result, the spatial extent and configuration of the high-emission spatial zone may vary over time in response to dynamic traffic conditions, congestion patterns, or emission fluctuations. This dynamic recalculation ensures that the route-search graph topology used for each route computation cycle reflects current emission conditions rather than static or outdated data. By recalculating the high-emission spatial zone prior to constructing the route-search graph topology, the system 100 maintains both environmental responsiveness and computational efficiency. Only those nodes and edges associated with currently elevated carbon-emission levels are excluded from the subgraph, thereby preserving routing flexibility while continuing to reduce computational load. This adaptive mechanism enables the system 100 to support real-time or near-real-time carbon-aware routing in dynamic traffic environments.

In one embodiment, the processing circuit 40 adjusts a spatial boundary of the route search region Rrs according to a distance between the current location Lcu and the destination Des, and constructs the route search region Rrs using road segments within the adjusted spatial boundary. The distance between the current location Lcu and the destination Des may be determined based on a straight-line geographic distance, an estimated travel distance along the road network, or an estimated travel time. Based on the determined distance, the processing circuit 40 adaptively scales the spatial boundary so that shorter trips correspond to a relatively narrower boundary, while longer trips correspond to a broader boundary encompassing a larger portion of the road network. The adjusted spatial boundary may be defined as a buffer region surrounding a preliminary reference path, a bounding box covering the current location Lcu and the destination Des, or a radius-based geographic area centered along the general travel corridor. The processing circuit 40 then identifies and extracts road segments and associated intersections that fall within the adjusted spatial boundary to construct the route search region Rrs. Road segments outside the spatial boundary may be excluded from further route computation. By dynamically adjusting the spatial boundary in proportion to the current location-destination distance, the system 100 prevents unnecessary inclusion of distant or irrelevant road segments in the route search region Rrs. This adaptive construction of the route search region Rrs reduces the size of the graph considered for route computation, thereby lowering computational complexity and improving efficiency while maintaining sufficient routing flexibility for the given travel distance.

In one embodiment, the processing circuit 40 further reintroduces one or more nodes and associated edges previously excluded due to being located within the high-emission spatial zone into the subgraph when no feasible candidate route is constructed in the subgraph. After constructing the route-search graph topology by excluding the high-emission spatial zone, the processing circuit 40 performs route computation to determine whether a feasible candidate route exists between the current location Lcu and the destination Des. When the route computation fails to produce the feasible candidate route, for example due to graph disconnection or excessive pruning of nodes and edges, the processing circuit 40 may selectively restore portions of the previously excluded graph elements. The reintroduction process may be performed incrementally. In some implementations, the nodes and the edges located at or near a boundary of the high-emission spatial zone are restored first, followed by additional nodes and edges in order of increasing carbon-emission level or decreasing proximity to the origin-destination corridor. In other embodiments, restoration may be guided by a priority metric, such as minimal emission increase, shortest detour distance, or limited expansion of the search space. After reintroducing selected nodes and edges, the processing circuit 40 reconstructs the route-search graph topology and repeats the route computation process. This adaptive reintroduction mechanism ensures that the feasible candidate route can ultimately be generated while maintaining the objective of minimizing exposure to high-emission spatial zones. At the same time, the system 100 preserves computational efficiency by initially operating on a reduced subgraph and only expanding the graph when necessary, thereby balancing routing feasibility and computational load reduction.

In one embodiment, the memory unit 20 stores the road network data as a directed graph data structure including a plurality of nodes and a plurality of edges, and the processing circuit 40 constructs the route-search graph topology by selecting a subset of the nodes and the edges from the directed graph data structure. The memory unit 20 stores the road network data as a directed graph data structure including a plurality of nodes and a plurality of edges. Each node may represent an intersection, waypoint, or discretized location within a geographic coordinate system, and each edge may represent a road segment connecting two nodes. The directed graph data structure may preserve edge directionality to reflect one-way streets, turn restrictions, traffic regulations, or asymmetric travel costs. In addition, each node and edge may be associated with attribute data, such as distance, speed limit, traffic density, and carbon-emission-related parameters. The processing circuit 40 constructs the route-search graph topology by selecting a subset of the nodes and edges from the directed graph data structure. In particular, after defining the route search region Rrs and excluding the high-emission spatial zones, the processing circuit 40 identifies nodes located within the route search region Rrs but outside the high-emission spatial zones, and selects edges whose source node and destination nodes both satisfy the selection criteria. The selected nodes and edges collectively form a subgraph of the original directed graph data structure. This subgraph serves as the route-search graph topology for subsequent route computation. By constructing the route-search graph topology as a subset of the directed graph data structure, the system 100 avoids duplicating the entire road network representation and instead performs logical filtering or masking operations on the stored graph. This approach enables efficient subgraph extraction while preserving the structural properties of the directed graph, thereby supporting accurate and computationally efficient route computation.

In one embodiment, excluding the high-emission spatial zones reduces a number of memory access operations required during route computation and improves cache utilization efficiency and reduces memory latency of the processing circuit 40. When the nodes and the edges associated with the high-emission spatial zones are removed or excluded for computation, the resulting route-search graph topology contains fewer graph elements to be traversed, evaluated, or updated during execution of a pathfinding algorithm. As a result, the processing circuit 40 performs fewer read and write operations to the memory unit 20 when accessing node attributes, edge weights, adjacency lists, or priority queue data structures. In addition, because the reduced subgraph occupies a smaller memory footprint, a greater proportion of the graph data structures may reside within higher-speed cache memory levels of the processing circuit 40. This improved locality of reference enhances cache hit rates and decreases latency associated with fetching data from main memory. Consequently, route computation algorithms, such as shortest-path or cost-optimization procedures, may execute with fewer cache misses and reduced memory bandwidth consumption. By lowering both the total number of memory access operations and the average memory access latency, exclusion of the high-emission spatial zones contributes not only to reduced algorithmic complexity but also to improved hardware-level efficiency. This optimization enhances overall system responsiveness, particularly in large-scale road networks or real-time routing applications where memory access patterns significantly influence computational performance.

In one embodiment, the processing circuit 40 performs parallel route computations on multiple subgraphs derived from partitioning the route search region Rrs to further reduce computation time. After defining the route search region Rrs, the processing circuit 40 may partition the route search region Rrs into a plurality of subregions based on geographic segmentation, graph clustering, corridor decomposition, or load-balancing criteria. Each subregion corresponds to a respective subgraph containing a subset of nodes and edges derived from the road network data. The processing circuit 40 may assign route computation tasks for the respective subgraphs to multiple processing cores, or hardware threads in the processing circuit 40. In implementations supporting multi-core or multi-processor architectures, each core may independently execute a pathfinding algorithm, or other cost-optimization procedures, on its assigned subgraph. Intermediate route candidates generated from the respective subgraphs may then be merged, compared, or further refined to determine a final candidate route between the current location Lcu and the destination Des. In some embodiments, the partitioning process may be configured to minimize cross-boundary dependencies by limiting interconnections between subgraphs or by predefining gateway nodes through which candidate routes may transition between subgraphs. Load balancing strategies may also be applied to ensure that computational workloads are distributed evenly across processing units. By enabling parallel route computations across multiple subgraphs, the system 100 reduces overall computation time and improves scalability for large or complex route search regions. This parallelization mechanism complements the exclusion of high-emission spatial zones and further enhances computational efficiency in carbon-aware routing scenarios.

In one embodiment, the processing circuit 40 partitions the route search region Rrs into a plurality of subgraphs based on a load-balancing criterion that distributes the nodes and the edges across multiple processing units, performs parallel route computations on the plurality of subgraphs, and reconciles boundary nodes between adjacent subgraphs to construct the candidate route. The load-balancing criterion may consider factors such as the number of the nodes, number of the edges, estimated computational complexity, traffic density distribution, or historical execution time associated with different portions of the road network. By allocating substantially balanced graph segments to respective processing cores or processing units, the system 100 avoids uneven workload distribution that could otherwise degrade parallel performance. Each subgraph includes a subset of nodes and associated edges derived from the directed graph data structure of the road network. The processing circuit 40 performs route computations in parallel on the plurality of subgraphs using separate execution threads or cores. In some embodiments, each processing unit independently computes partial route candidates within its assigned subgraph, including distance costs, emission costs, or combined objective metrics. Because partitioning may introduce boundary nodes located at interfaces between adjacent subgraphs, the processing circuit 40 further reconciles boundary nodes to construct the candidate route. Reconciliation may include exchanging intermediate path costs associated with shared or gateway nodes, synchronizing accumulated route metrics, and merging partial route segments that traverse multiple subgraphs. In some implementations, a coordinating module aggregates the results from the parallel computations and determines a globally optimal or near-optimal candidate route connecting the current location Lcu and the destination Des. Through load-balanced partitioning, parallel route computation, and boundary-node reconciliation, the system 100 achieves improved computational efficiency while preserving routing correctness across the entire route search region Rrs.

The present invention has been disclosed with reference to the above embodiments, which are not intended to limit the spirit and scope of the present invention. A person skilled in the art to which the present disclosure pertains may make various modifications and adjustments without departing from the spirit and scope of the present disclosure. Accordingly, the scope of protection of the present invention can be defined by the claims.

What is claimed is:

1. A system for monitoring vehicle carbon footprint and reducing computational load in carbon-aware vehicle routing, including:
at least one memory unit storing road network data; and
at least one processing circuit operatively coupled to the memory unit, wherein the processing circuit executes an application program to:
define a route search region between a current location and a destination a transportation vehicle based on the road network data;
identify a plurality of assessment points within the route search region, and determine that at least one of the assessment points is a high-emission point when a carbon-emission level of the at least one assessment point exceeds a predefined threshold;
define at least one high-emission spatial zone within the route search
region, by a proximity distance relative to the high-emission point, or by graph connectivity relationship between a plurality of adjacent high-emission points;
construct a route-search graph topology with a plurality of nodes representing intersections and a plurality of edges representing road segments in a subgraph of the road network data corresponding to the route search region and excluding the high-emission spatial zone, wherein the route-search graph topology includes fewer nodes and fewer edges to reduce a resource intensity of route computation over the subgraph than over a graph corresponding to the route search region including the high-emission spatial zone, thereby reducing computational load of the processing circuit; and
construct a candidate route by performing route computation on the route-search graph topology.

2. The system of claim 1, wherein the carbon-emission level of each assessment point is determined based on at least one of: real-time traffic density data, average vehicle speed data, or historical carbon footprint records used to estimate the carbon-emission level and compare the carbon-emission level with the predefined threshold.

3. The system of claim 1, wherein the transportation vehicle is selected from a group consisting of bicycle, electric bicycle (E-bike), motorcycle, scooter, electric motorcycle, electric scooter, gasoline-powered vehicle, and electric vehicle.

4. The system of claim 1, wherein the assessment points correspond to intersections, road-segment midpoints, or discretized coordinate grid points derived from the road network data.

5. The system of claim 1, wherein defining the high-emission spatial zone based on the proximity distance includes applying a region-growing algorithm that expands from the high-emission point until a boundary condition is satisfied.

6. The system of claim 1, wherein defining the high-emission spatial zone based on the graph connectivity relationship includes performing a connected-component analysis on the adjacent high-emission points.

7. The system of claim 1, wherein the high-emission spatial zone is represented as a polygonal boundary defined in a geographic coordinate system or as a node set in a directed graph data structure.

8. The system of claim 1, wherein the processing circuit dynamically recalculates the high-emission spatial zone prior to each route computation cycle based on updated carbon-emission levels of the assessment points.

9. The system of claim 1, wherein the processing circuit adjusts a spatial boundary of the route search region according to a distance between the current location and the destination, and constructs the route search region using road segments within the adjusted spatial boundary.

10. The system of claim 1, wherein the processing circuit further reintroduces one or more nodes and associated edges previously excluded due to being located within the high-emission spatial zone into the subgraph when no feasible candidate route is constructed in the subgraph.

11. The system of claim 1, wherein the memory unit stores the road network data as a directed graph data structure including the nodes and the edges, and the processing circuit constructs the route-search graph topology by selecting a subset of the nodes and the edges from the directed graph data structure.

12. The system of claim 1, wherein excluding the high-emission spatial zone reduces a number of memory access operations required during route computation and improves cache utilization efficiency and reduces memory latency of the processing circuit.

13. The system of claim 1, wherein the processing circuit performs parallel route computations on multiple subgraphs derived from partitioning the route search region to further reduce computation time.

14. The system of claim 13, wherein the processing circuit partitions the route search region into a plurality of subgraphs based on a load-balancing criterion that distributes nodes and edges across multiple processing units, performs parallel route computations on the plurality of subgraphs, and reconciles boundary nodes between adjacent subgraphs to construct the candidate route.
